(19) United States
(12) Patent Application Publication
(10) Pub. No.: US 2025/0086635 A1
(43) Pub. Date: Mar. 13, 2025

(54) Multi-Computer System for Dynamic Mapping Interface Generation

(71) Applicant: Bank of America Corporation, Charlotte, NC (US)

(72) Inventors: Jack Franklin Price, Jr., McKinney, TX (US); Basil C. Doyle, Chicago, IL (US); Allison M. Glenn, Chicago, IL (US); Benjamin F. Tweel, Romeoville, IL (US); Sara B. Roper, Arvado, CO (US); Susan Hart, Anna, TX (US); Christopher Cooley, Longmont, CO (US)

(21) Appl. No.: 18/244,419

(22) Filed: Sep. 11, 2023

(51) Int. Cl. G06Q 20/40; G06F 3/04817; G06F 3/04842; G06Q 20/38

(52) U.S. Cl. CPC G06Q 20/4016; G06F 3/04817; G06F 3/04842; G06Q 20/389

(57) ABSTRACT

Arrangements for dynamic generation of interactive mapping interfaces are provided. Transaction data may be received by a computing platform and analyzed to extract user and location information for each transaction. The computing platform may generate, based on the extracted user and location data, an interactive mapping interface providing a visual display of transactions within a geographic area. The interactive mapping interface may include a plurality of interactive icons that identify a physical location of a transaction. The interactive mapping interface may be transmitted to a user computing device for display by a display of the user computing device. The computing platform may receive user input associated with user interaction with one of the interactive icons and may generate and transmit, to the user computing device for display, an additional user interface that may include transaction details and a selectable option to report the respective transaction as fraudulent.

### BACKGROUND

Aspects of the disclosure relate to electrical computers, systems, and devices providing dynamic mapping interface generation.

Quickly identifying potential unauthorized activity in both event processing and device or application logins is critical for users to mitigate impact of fraudulent activity. However, viewing event processing data and/or login data in text form and/or list form might not be informative enough for a user to determine whether a transaction is fraudulent. Accordingly, it would be advantageous to dynamically generate an interactive mapping interface to provide a visual representation of event processing and/or login data for users to identify potential unauthorized activity.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated dynamically generating graphical displays of user event processing and/or login data to identify and report fraudulent activity.

In some examples, transaction data may be received by a computing platform. The transaction data may include a plurality of transactions executed by a plurality of users. The plurality of users may be registered customers of an enterprise organization. The transaction data may be analyzed to extract user and location information for each transaction of the plurality of transactions. In some examples, machine learning may be used to analyze the transaction data.

In some arrangements, the computing platform may generate, based on the extracted user and location data, an interactive mapping interface providing a visual display of transactions within a geographic area. In some examples, the interactive mapping interface may include a plurality of interactive icons or interface elements that identify a physical location of a transaction on the interactive mapping interface. The interactive mapping interface may be transmitted to a user computing device for display by a display of the user computing device.

In some examples, the computing platform may receive user input associated with user interaction with one of the interactive icons. Responsive to receiving the user input, an additional user interface may be generated and transmitted to the user computing device for display. In some examples, the additional user interface may include transaction details associated with the transactions associated with the icon selected by the user. In some examples, the additional user interface may include a selectable option to report the respective transaction as fraudulent. In some arrangements, selection of the selectable option may cause initiation of a communication session between a fraud reporting computer system and the user computing device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing interactive mapping interface generation in accordance with one or more aspects described herein;

FIGS. 2A-2F depict an illustrative event sequence for implementing interactive mapping interface generation in accordance with one or more aspects described herein;

FIG. 3 depicts an illustrative method for implementing interactive mapping interface generation in accordance with one or more aspects described herein;

FIGS. 4A-4C illustrate example interactive mapping interfaces and additional interfaces that may be generated in accordance with one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, quickly evaluating login occurrences and/or processed events to identify potential unauthorized activity is critical for users to protect their data, accounts, and the like. Accordingly, arrangements described herein provide dynamic generation of interactive mapping interfaces to provide a visualization of user events and login attempts. Users may view different data layers to see different types of transactions, types of events, via a map view to visualize a physical location of a transaction or login attempt. Accordingly, if a user does not recognize a transaction or login attempt, the user may select an icon associated with the event to view additional transaction details via an additional user interface. In some examples, the additional user interface may include a selectable option to report the transaction as potential fraudulent. In some examples, selection of that option may cause initiation of a communication session between a fraud reporting computing system and a user computing device.

These and various other arrangements will be discussed more fully below.

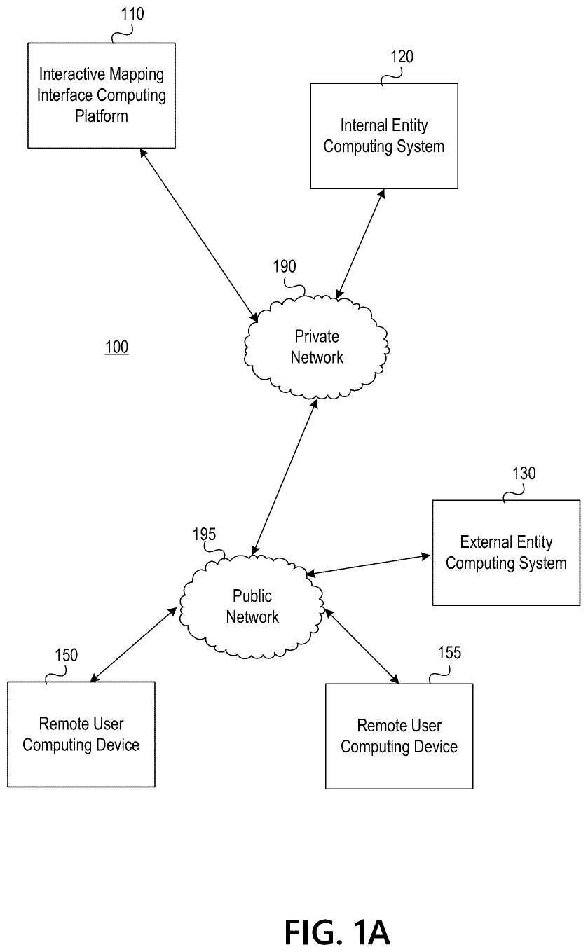

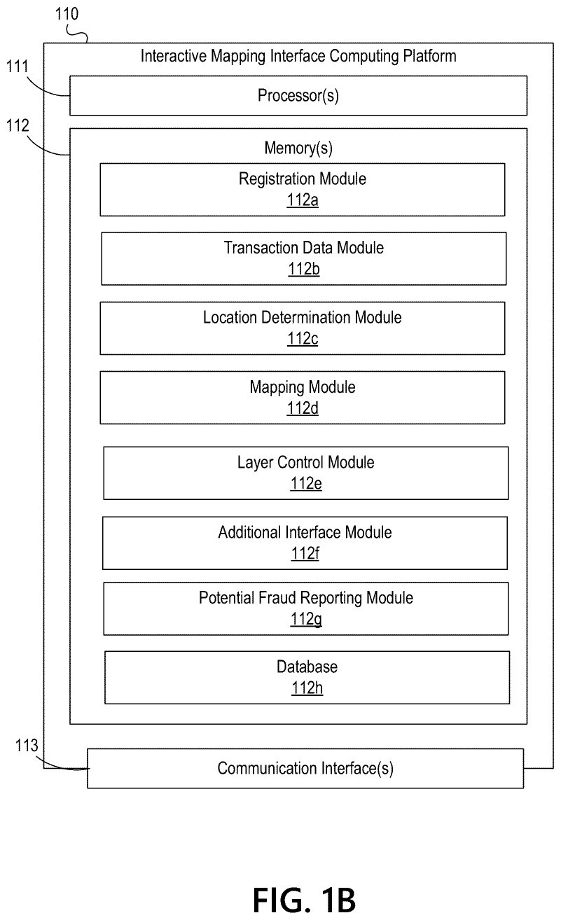

FIGS. 1A-1B depict an illustrative computing environment for implementing dynamic interactive mapping functions in accordance with one or more aspects described herein. Referring to FIG. 1A, computing environment 100 may include one or more computing devices and/or other computing systems. For example, computing environment 100 may include interactive mapping interface computing platform 110, internal entity computing system 120, external entity computing system 130, remote user computing device 150 and remote user computing device 155. Although one internal entity computing system 120, one external entity computing system 130 and two remote user computing devices 150, 155 are shown, more or fewer devices or systems may be used without departing from the invention. Further, while interactive mapping interface computing platform 110 is shown as a separate device from internal entity computing system 120, in some examples, interactive mapping interface computing platform 110 and internal entity computing system 120 may be part of a same device.

Interactive mapping interface computing platform 110 may be or include one or more computing devices (e.g., servers, server blades, or the like) and/or one or more computing components (e.g., memory, processor, and the like) and may be configured to provide dynamic, efficient interactive mapping interface generation and modification. For instance, interactive mapping interface computing platform 110 may receive transaction data associated with a plurality of transactions for a plurality of users (e.g., customers of an enterprise organization, such as a financial institution). The transaction data may include a type of payment device used (e.g., debit card, credit card, mobile payment application, or the like), type of payment (e.g., online, in person, or the like), amount of the transaction, vendor or party to the transaction, time and date of the transaction, and location information associated with the transaction. For instance, a location of a vendor who is a party to the transaction may be included in the transaction data. In some examples, a location of a user or customer transacting with the vendor may also be included in the transaction data (e.g., based on, for instance, an internet protocol address associated with a computing device used to make a purchase via a mobile application executing on the computing device). In examples in which the transaction is an in person transaction, the location of the vendor and user or customer may be known based on the location of the vendor (e.g., the user is making an in person purchase at the vendor location specified in the transaction information so both the vendor and customer are located physically at the vendor location at the time of the transaction).

The transaction information may be parsed or otherwise processed to identify and group user transactions. For instance, machine learning (e.g., one or more clustering algorithms) may be used to identify transaction associated with a particular user and cluster those transactions. In some examples, the interactive mapping interface computing platform may further process the transaction information to extract location information for each transaction associated with a particular user.

Interactive mapping interface computing platform 110 may dynamically generate an interactive mapping interface based on the processed transaction data. For instance, an interactive map interface may be generated showing various geographical locations and may include interactive icons or interface elements that may indicate a physical location, on the interactive map, of one or more transactions associated with a user and identified from the processed transaction data. In some examples, the interactive mapping interface may be dynamically generated for an individual user or household of users (e.g., based on linked or joint accounts, shared payment card accounts, or the like). Accordingly, the interactive mapping interface may be personalized for a user and show only transactions associated with that user, user account, payment card, or the like.

In some examples, interactive mapping interface computing platform 110 may generate additional interactive user interfaces that may be displayed upon selection of or interaction with (e.g., click, double click, hover over) an icon or interface element associated with a transaction. For instance, user selection of or interaction with an icon associated with a first transaction may cause interactive mapping interface computing platform 110 to generate and display a user interface providing transaction details to the user (e.g., vendor name, street address, date and time of transaction, amount of transaction, type of payment device used, or the like). In some examples, the transaction details user interface may include a selectable element that may be selected to indicate that a transaction includes potentially fraudulent activity. Selection of the selectable element may cause the user to be connected to a fraud reporting system of the enterprise organization.

In some arrangements, interactive mapping interface computing platform 110 may generate data layers for display via the interactive mapping interface. For instance, data layers associated with all users in a household, each user within a household, different payment methods or devices, types of transactions (e.g., online or in person) or the like, may be generated. The layered data may be displayed via selection of one or more layers for display by the user. Accordingly, the user may customize the data shown on the interactive mapping interface by selecting or de-selecting one or more data layers for display.

Internal entity computing system 120 may be or include one or more computing devices (e.g., servers, server blades, or the like) and/or one or more computing components (e.g., memory, processor, and the like) and may be configured to host or execute one or more applications associated with the enterprise organization, such as customer facing application (e.g., a web-based or mobile application), internal applications associated with user accounts, customer data management, transaction processing, fraud reporting, or the like. In some examples, internal entity computing system 120 may store customer transaction data associated with a plurality of transactions executed by a plurality of users or customers of the enterprise organization. The transaction data may include user identifying information, type of payment device used, time, date, vendor or party to the transaction, location data, and the like. Additionally or alternatively, internal entity computing system 120 may host one or more systems or applications configured to receive reports of fraudulent or potentially fraudulent activity, initiate investigations, execute instructions to modify account settings (e.g., change password or personal identification number, or the like), disable or otherwise freeze a payment device, replace a payment device, or the like.

External entity computing system 130 may be or include one or more computing devices (e.g., servers, server blades, or the like) and/or one or more computing components (e.g., memory, processor, and the like) and may be associated with an entity external to the enterprise organization, such as a vendor at which customers of the enterprise organization have executed transactions. In some examples, interactive mapping interfaces may be generated for vendor review to identify or visualize reports of potential fraud at various locations of the vendor.

Remote user computing device 150 and/or remote user computing device 155 may be or include computing devices such as desktop computers, laptop computers, tablets, smartphones, wearable devices, and the like, that may be associated with a user or customer (e.g., a customer of the enterprise organization). Remote user computing device 150 may be a device associated with a same user as associated with remote user computing device 155, or a different user. Remote user computing device 150, 155 may, in some examples, conduct or execute transactions (e.g., online transactions using different payment methods or devices, transactions using a mobile payment application, or the like). In some examples, remote user computing device 150 and/or remote user computing device 155 may be configured to display the dynamically generated interactive mapping interface and/or any additional interfaces, control display of data via the interactive mapping interface by selecting or de-selecting data layers, report potentially fraudulent transactions via the interactive mapping interface, and the like.

As mentioned above, computing environment 100 also may include one or more networks, which may interconnect one or more of interactive mapping interface computing platform 110, internal entity computing system 120, external entity computing system 130, remote user computing device 150 and/or remote user computing device 155. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, interactive mapping interface computing platform 110, and/or internal entity computing system 120 may be associated with an enterprise organization (e.g., a financial institution), and private network 190 may be associated with and/or operated by the organization, and may include one or more networks (e.g., LANs, WANs, virtual private networks (VPNs), or the like) that interconnect interactive mapping interface computing platform 110, and/or internal entity computing system 120 and one or more other computing devices and/or computer systems that are used by, operated by, and/or otherwise associated with the organization. Public network 195 may connect private network 190 and/or one or more computing devices connected thereto (e.g., interactive mapping interface computing platform 110, internal entity computing system 120,) with one or more networks and/or computing devices that are not associated with the organization. For example, external entity computing system 130, remote user computing device 150 and/or remote user computing device 155 might not be associated with an organization that operates private network 190 (e.g., because external entity computing system 130, remote user computing device 150 and/or remote user computing device 155 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 130, remote user computing device 150 and/or remote user computing device 155 to private network 190 and/or one or more computing devices connected thereto (e.g., interactive mapping interface computing platform 110, internal entity computing system 120).

Referring to FIG. 1B, interactive mapping interface computing platform 110 may include one or more processors 111, memory 112, and communication interface 113. A data bus may interconnect processor(s) 111, memory 112, and communication interface 113. Communication interface 113 may be a network interface configured to support communication between interactive mapping interface computing platform 110 and one or more networks (e.g., network 190, network 195, or the like). Memory 112 may include one or more program modules having instructions that when executed by processor(s) 111 cause interactive mapping interface computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of interactive mapping interface computing platform 110 and/or by different computing devices that may form and/or otherwise make up interactive mapping interface computing platform 110.

For example, memory 112 may have, store and/or include registration module 112a. Registration module 112a may store instructions and/or data that may cause or enable the interactive mapping interface computing platform 110 to receive, from one or more users or customers, a request to register with the interactive mapping interface computing platform 110. For instance, users or customers of the enterprise organization may opt in to have transaction data presented via an interactive mapping interface generated by interactive mapping interface computing platform 110. Accordingly, users may provide permissions to the interactive mapping interface computing platform 110 to receive and analyze transaction data associated with the user, user accounts, other household members who may share accounts or payment devices, or the like. In some examples, the registration data may include identification of other users who are members of the user's household and who may execute transactions using one or more payment devices, accounts, or the like, associated with the user.

Interactive mapping interface computing platform 110 may further have, store and/or include transaction data module 112b. Transaction data module 112b may store instructions and/or data that may cause or enable the interactive mapping interface computing platform 110 to receive transaction data associated with a plurality of transactions and a plurality of users. In some examples, the users may be customers of the enterprise organization associated with the interactive mapping interface computing platform 110. The transaction data may include identification of the user, vendors or other parties to the transaction, amount of transaction, type of transaction, type of payment device used, account associated with the transaction, location of the user and/or vendor, and the like. In some examples, transaction data module may include a machine learning engine that may be used to analyze the transaction data, cluster data by user, or the like.

Interactive mapping interface computing platform 110 may further have, store and/or include location determination module 112c. Location determination module 112c may store instructions and/or data that may cause or enable the interactive mapping interface computing platform 110 to extract, from the transaction data, location data associated with one or more of the user, vendor, or the like. In some examples, such as in person transactions, the location of the vendor may be identified as the location of the user as well. For online transactions, a location of the vendor may be identified. Additionally or alternatively, if a user is using a mobile payment application, an IP address of the user device may be used to identify a location of the user at the time of the transaction.

Interactive mapping interface computing platform 110 may further have, store and/or include mapping module 112d. Mapping module 112d may store instructions and/or data that may cause or enable the interactive mapping interface computing platform 110 generate an interactive mapping interface displaying the location information identified from the transaction data. For instance, a map showing a geographic location and transactions of a user within that geographic location may be generated. The map may include one or more icons or interactive interface elements that may indicate a physical location of one or more of the user and/or the vendor for a transaction.

Interactive mapping interface computing platform 110 may further have, store and/or include layer control module 112e. Layer control module 112e may store instructions and/or data that may cause or enable the interactive mapping interface computing platform 110 to generate one or more data layers for display and selectively display the data layers based on user input. For instance, users may select to display data associated with just the user, the household of users, a particular payment device, a particular date, range, a particular type of transaction, or the like. Accordingly, the layer control module 112e may be used in conjunction with the transaction data module 112b and associated machine learning engine to generate different layers of data for display.

Interactive mapping interface computing platform 110 may further have, store and/or include additional interface module 112f. Additional interface module 112f may store instructions and/or data that may cause or enable the interactive mapping interface computing platform 110 to dynamically generate one or more additional user interfaces based on, for instance, user interaction with or selection of an icon or interactive element indicating a transaction on the interactive mapping interface. The one or more additional interfaces may include additional transaction details, a selectable option to report potential fraud, or the like.

Interactive mapping interface computing platform 110 may further have, store and/or include potential fraud reporting module 112g. Potential fraud reporting module 112g may store instructions and/or data that may cause or enable the interactive mapping interface computing platform 110 to establish a connection with an enterprise organization fraud reporting platform and transmit a report of potential fraud to the enterprise organization fraud reporting platform. In some examples, the connection may include causing display of a user interface associated with the enterprise organization fraud reporting platform to the user. Further, in some examples, potential fraud reporting module 112g may generate and transmit notifications to one or more other groups within the enterprise organization indicating potential fraud (e.g., relationship management teams, or the like).

Interactive mapping interface computing platform 110 may further have, store and/or include a database 112h. Database 112h may store data associated with user registration, transactions, generated data layers, potential fraud reports, and/or other data that enables performance of the aspects described herein by the interactive mapping interface computing platform 110.

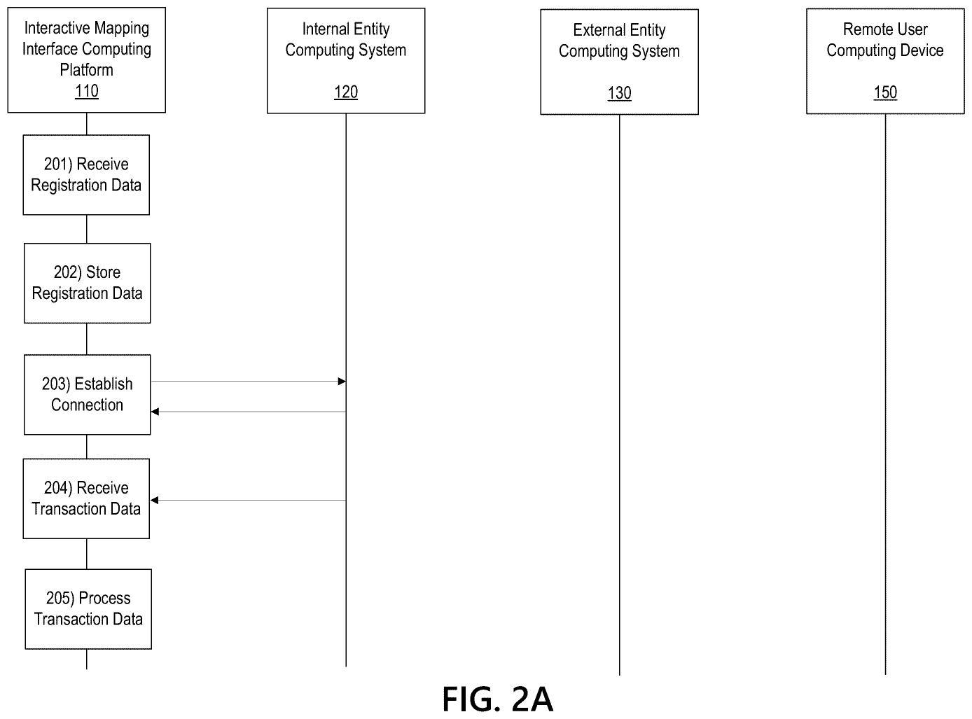

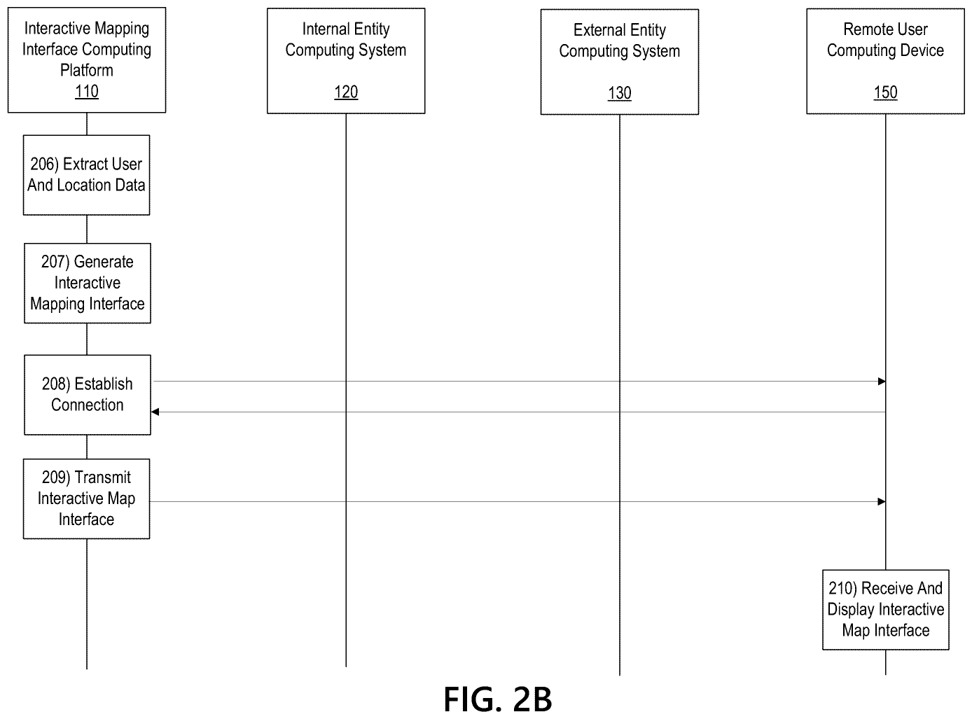

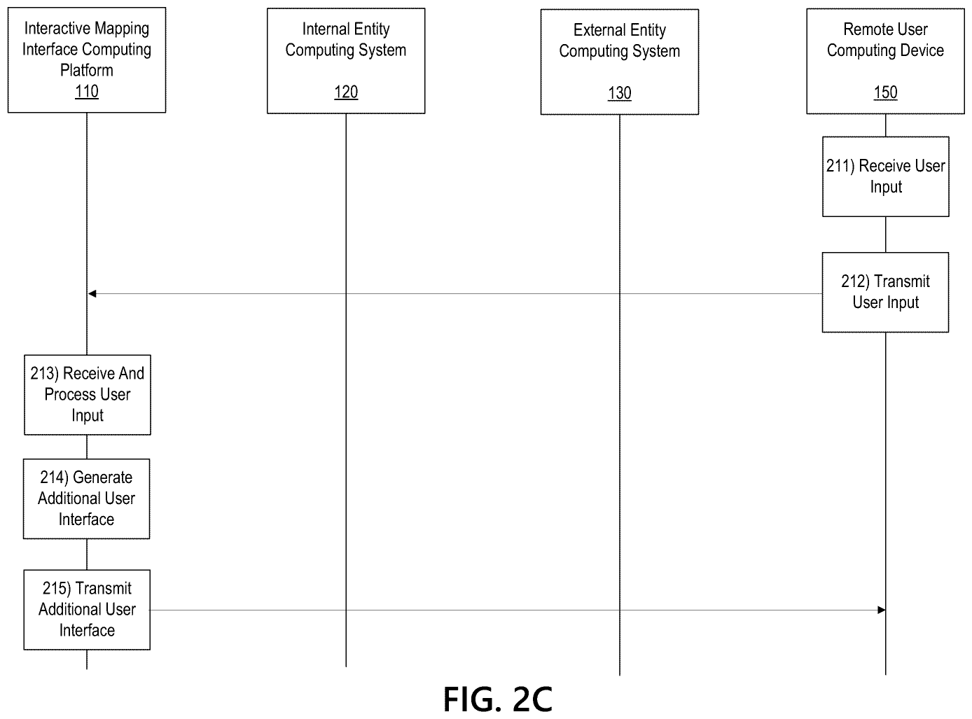

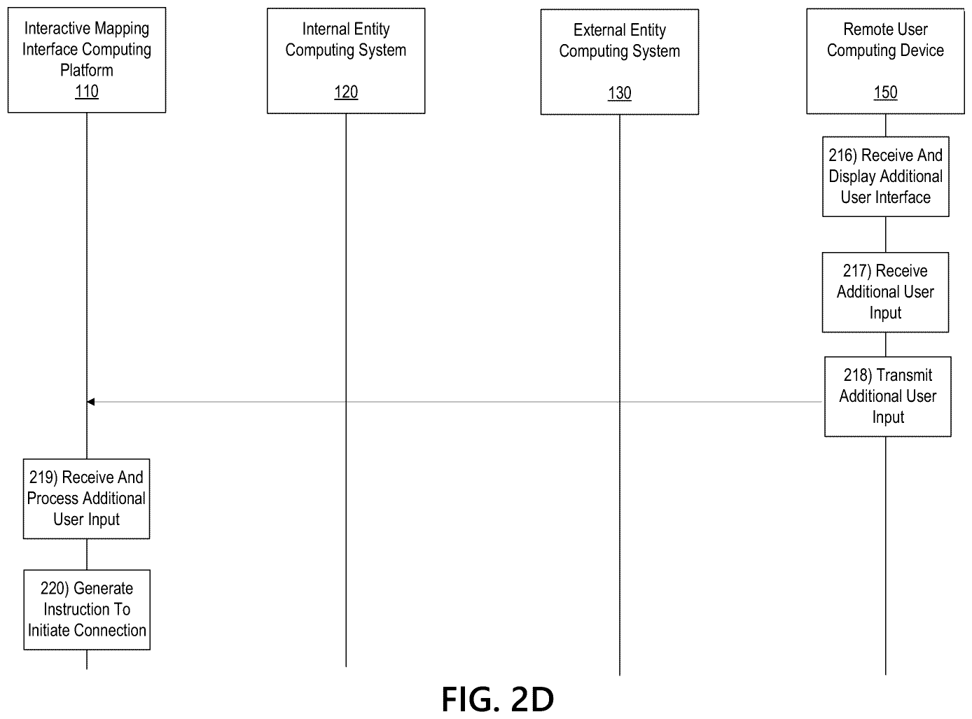

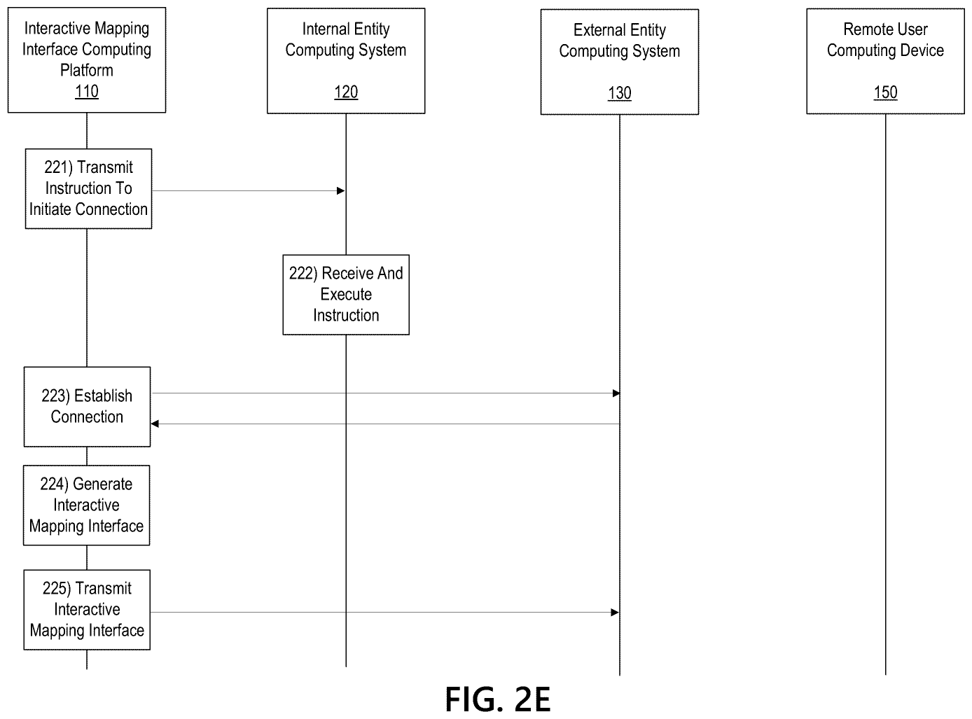

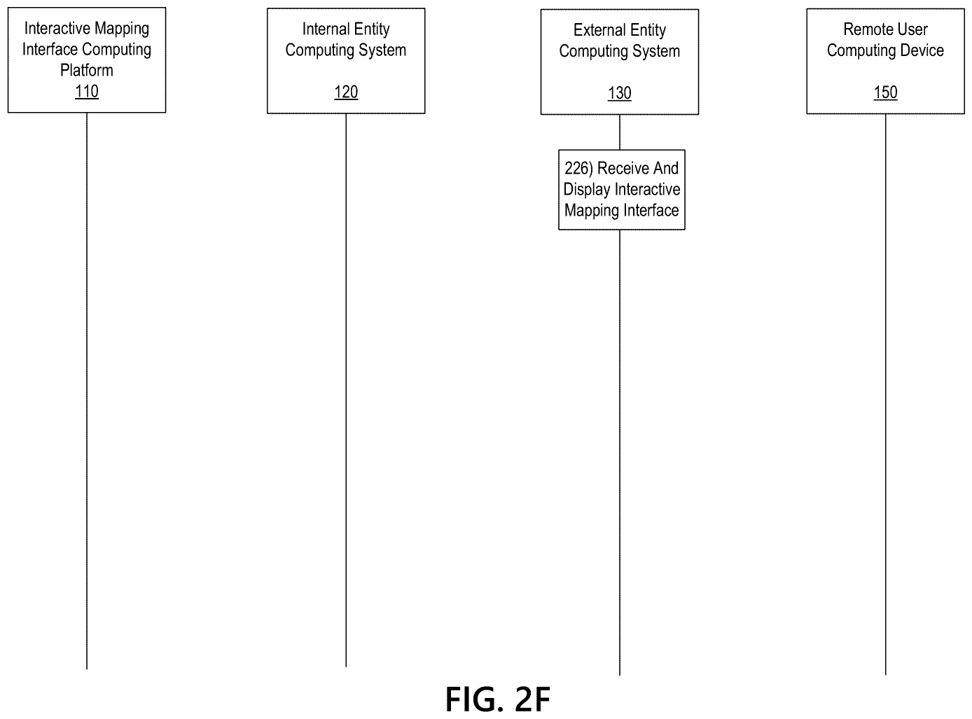

FIGS. 2A-2F depict one example illustrative event sequence for implementing interactive mapping interface generation in accordance with one or more aspects described herein. The events shown in the illustrative event sequence are merely one example sequence and additional events may be added, or events may be omitted, without departing from the invention. Further, one or more processes discussed with respect to FIGS. 2A-2F may be performed in real-time or near real-time.

With reference to FIG. 2A, at step 201, interactive mapping interface computing platform 110 may receive registration data. For instance, interactive mapping interface computing platform 110 may receive registration data from a plurality of users or customers of the enterprise organization implementing the interactive mapping interface computing platform 110. The registration data may include user identifying data, user account data, user payment device data, additional user data (e.g., household or shared account users), user customization options, user permissions (e.g., to access transaction data) and the like.

At step 202, the interactive mapping interface computing platform 110 may store the received registration data. For instance, for each user identified in the registration data, interactive mapping interface computing platform 110 may modify a database to include a data entry associated with the user, registration data for the user, and the like.

At step 203, interactive mapping interface computing platform 110 may establish a connection with the internal entity computing system 120. For instance, a first wireless connection may be established between the interactive mapping interface computing platform 110 and the internal entity computing system 120. Upon establishing the first wireless connection, a communication session may be initiated between the interactive mapping interface computing platform 110 and the internal entity computing system 120.

At step 204, interactive mapping interface computing platform 110 may receive transaction data from the internal entity computing system 120. For instance, transaction data including users, vendors, location information, time, date, type of transaction, payment device, and the like, may be received from the internal entity computing system 120 for a plurality of transactions for a plurality of registered users. In some examples, the transaction data may be received on a continuous basis (e.g., data stream, periodic batch transfers, or the like). Accordingly, the transaction data may be received in real-time or near real-time in at least some arrangements.

At step 205, interactive mapping interface computing platform 110 may receive and process the transaction data. For instance, interactive mapping interface computing platform 110 may process the data using, for instance, a machine learning model (e.g., one or more clustering algorithms) to cluster data associated with a user. The data may be further processed to identify available data (e.g., location data, or the like) for presentation via the interactive mapping interface. In some examples, identifying location data may include identifying a location of a vendor of an in person transaction and associating the location of the vendor with the user conducting the in person transaction.

With reference to FIG. 2B, at step 206, user and location data may be extracted from the processed transaction data. For instance, location data for a plurality of transactions associated with a particular user may be extracted from the processed transaction data.

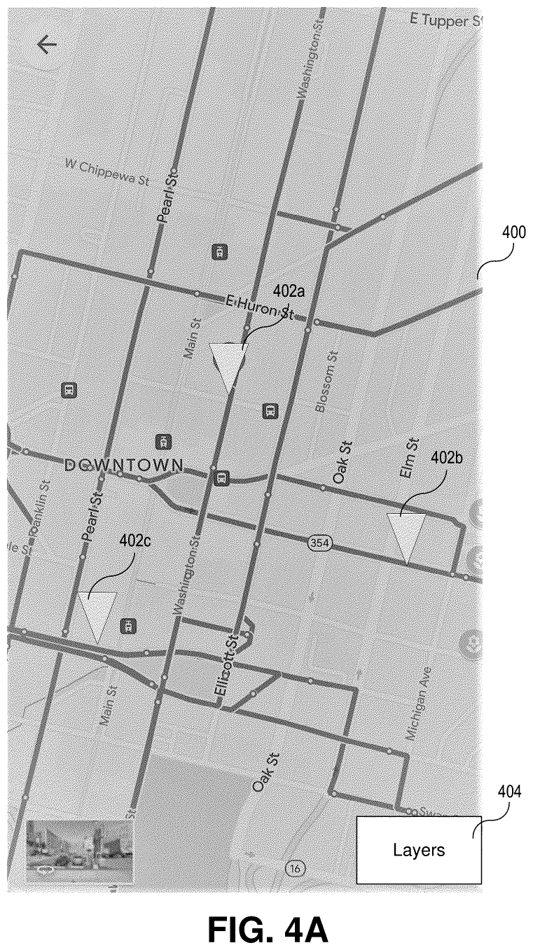

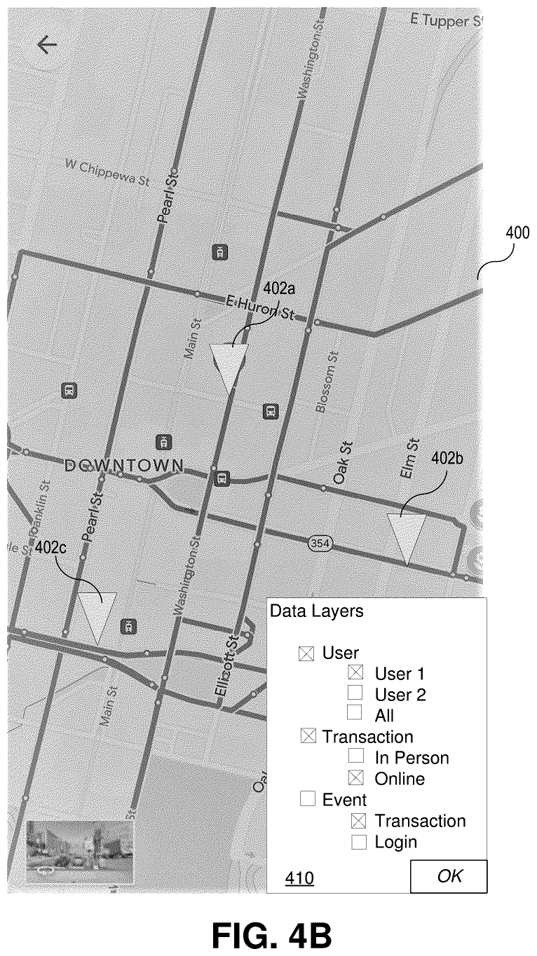

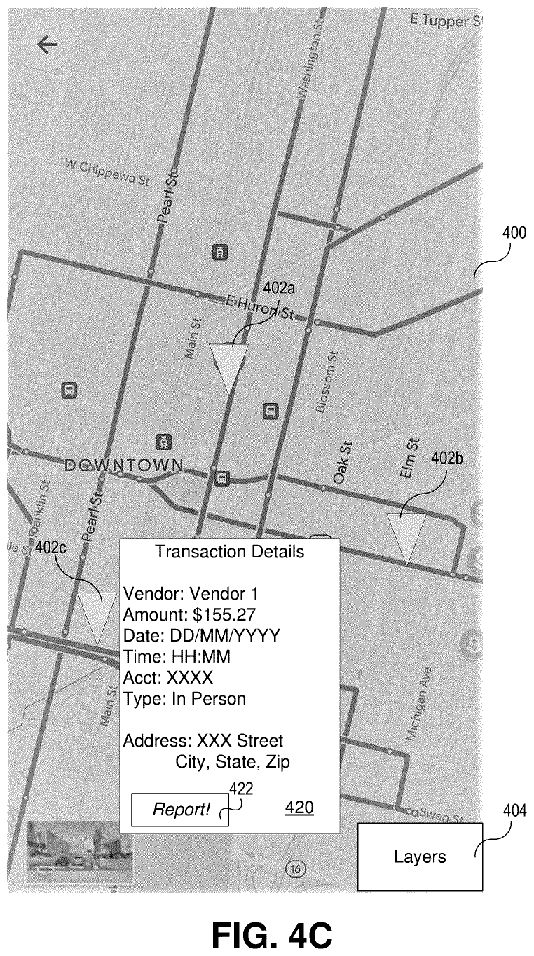

At step 207, interactive mapping interface computing platform 110 may generate an interacting mapping interface. For instance, interactive mapping interface computing platform 110 may dynamically generate an interactive interface including a map of a geographical location with the plurality of transactions displayed via one or more selectable icons or interactive elements at a respective physical location of the transaction (e.g., vendor location) and/or the user (if known). The interactive mapping interface may include options to display different data layers (e.g., one user, multiple users, different time periods, types of transactions, or the like). For instance, FIG. 4A illustrates one example interactive mapping interface 400. The interface includes a map of a geographic location with a plurality of icons or selectable interface elements 402a, 402b, 402c identifying physical locations of one or more transactions. While three transactions or events are shown in the interactive mapping interface 400, more of fewer events or transactions may be shown. Further, as a user expands or contracts the geographical area shown in the interactive mapping interface (e.g., by zooming in or out) more of fewer transactions may be displayed (e.g., based on the modified geographical location).

Interactive mapping interface 400 may further include a selectable option to modify the data layers displayed via the interactive mapping interface 400. For instance, selection of “layers” option 404 may cause generation of an additional user interface 410 (shown in FIG. 4B) that includes selectable options for display of different data layers within the interactive mapping interface 400. For instance, a user may select to view a data layer showing transaction data for one or more household members (e.g., alone or in combination with the user), data layers by transaction type (e.g., in person or online), data layers by event type (e.g., transaction, login attempt, or the like), or the like. The selectable data layers shown in FIG. 4B shown are merely some example data layers and additional data layers may be provided for selection without departing from the invention.

In some examples, different colors may be used to indicate different aspects of transactions. For instance, in some examples, transactions made using a first credit card may be shown in a first color while transactions made using a debit card may be shown in a second, different color. In another example, in person transactions may be shown in a first color while online transactions may be shown in a second, different color. Various other color arrangements may be used without departing from the invention.

At step 208, interactive mapping interface computing platform 110 may establish a connection with the remote user computing device 150. For instance, a second wireless connection may be established between the interactive mapping interface computing platform 110 and the remote user computing device 150. Upon establishing the second wireless connection, a communication session may be initiated between the interactive mapping interface computing platform 110 and the remote user computing device 150.

At step 209, interactive mapping interface computing platform 110 may transmit or send the interactive mapping interface to the remote user computing device 150. For instance, the interactive mapping interface may be transmitted or sent during the communication session initiated upon establishing the second wireless connection. In some examples, transmitting or sending the interactive mapping interface may cause the remote user computing device 150 to display the interactive mapping interface on a display of the remote user computing device 150.

At step 210, remote user computing device 150 may receive and display the interactive mapping interface transmitted at step 209.

With reference to FIG. 2C, at step 211, remote user computing device 150 may receive user input selecting or otherwise interacting with one of the icons or interactive interface elements in the interactive mapping interface. In some examples, selection of or interaction with the icon or interactive interface element may include clicking or double clicking the icon or interactive interface element, hovering over the icon or interactive interface element, or the like.

At step 212, the remote user computing device 150 may transmit or send the user input to the interactive mapping interface computing platform 110. For instance, an indication of the user selection of or interaction with the icon or interactive interface element, as well as an indication of which icon or interface element was selected, may be transmitted or sent to the interactive mapping interface computing platform 110.

At step 213, the interactive mapping interface computing platform 110 may receive and process the user input. For instance, interactive mapping interface computing platform 110 may identify a transaction associated with the selected icon or interactive interface element and may retrieve transaction details associated with the transaction.

At step 214, interactive mapping interface computing platform 110 may generate an additional user interface. In some examples, the additional user interface may include a transaction details interface providing additional details of the transaction associated with the user input. For instance, the transaction details interface may include a time and date of the transaction, name of vendor, amount of transaction, account identifier, payment device used, or the like. FIG. 4C illustrates one example additional user interface, such as a transaction details interface 420. The transactions details interface 420 may include additional transaction details, such as vendor name and address, date, time, amount of transaction, account or payment device used, and the like. In some examples, the transaction details interface may include a selectable option 422 to report the transaction as fraudulent or potentially fraudulent. In some examples, selection of option 422 may cause initiation of a communication session between a fraud reporting computing system and the user computing device displaying the interactive mapping interface 400 and the additional interface 420.

At step 215, interactive mapping interface computing platform 110 may transmit or send the additional user interface to the remote user computing device 150. In some examples, transmitting or sending the additional user interface may cause the remote user computing device 150 to display the additional user interface on the display of the remote user computing device 150.

With reference to FIG. 2D, at step 216, the remote user computing device 150 may receive and display the additional user interface. In some examples, displaying the additional user interface may include displaying the additional user interface as a pop-up or otherwise overlaying the interactive mapping interface. In some examples, the additional user interface may be display adjacent to or abutting the icon associated with the transaction.

At step 217, remote user computing device 150 may receive additional user input. For instance, a user may select a selectable option from the additional user interface to report the transaction as fraudulent or potentially fraudulent.

At step 218, remote user computing device 150 may transmit or send the additional user input to the interactive mapping interface computing platform 110. For instance, remote user computing device 150 may transmit or send the user input including a request to initiate a fraud report to the interactive mapping interface computing platform 110.

At step 219, interactive mapping interface computing platform 110 may receive and process the additional user input. For instance, interactive mapping interface computing platform 110 may identify the transaction and any additional information associated with the transaction.

At step 220, interactive mapping interface computing platform 110 may generate an instruction to initiate a connection. In some examples, the instruction may include an instruction to initiate a connection between an enterprise organization device or system associated with fraud reporting to the remote user computing device. For instance, the instruction may include an instruction to initiate a communication session between internal entity computing system 120 and remote user computing device. In some examples, the instruction may include transaction details related to the transaction and any additional information retrieved or identified by the interactive mapping interface computing platform 110 in receiving and processing the user input.

With reference to FIG. 2E, at step 221, interactive mapping interface computing platform 110 may transmit or send the generated instruction to the internal entity computing system 120.

At step 222, internal entity computing system 120 may receive and execute the generated instruction. In some examples, receiving and executing the instruction may cause the internal entity computing system 120 to initiate a communication session with remote user computing device. The communication session may include transmitting and displaying user interfaces on the remote user computing device 150 to enable the user to report the potential fraud. In some examples, the user interfaces may be pre-populated with transaction data included in the instruction to initiate the communication session.

Although aspects described herein have been described in the context of providing visual indications of transaction history for users or customers. in some examples, the transaction history may be used to provide visualized insights for one or more vendors. For instance, returning to step 205, the interactive mapping interface computing platform 110 may further process the data to cluster the data by vendor. Accordingly, if a vendor has more than one location, all transactions for any location of that vendor may be clustered and location data, as well as received reports of fraudulent activity may be aggregated with the vendor-based transaction data.

Accordingly, returning to FIG. 2E, at step 223, interactive mapping interface computing platform 110 may establish a connection with external entity computing system 130. For instance, a third wireless connection may be established between the interactive mapping interface computing platform 110 and the external entity computing system 130. Upon establishing the third wireless connection, a communication session may be initiated between the interactive mapping interface computing platform 110 and the external entity computing system 130.

At step 224, interactive mapping interface computing platform 110 may dynamically generate a vendor-based interactive mapping interface. The vendor-based interactive mapping interface may include identification of one or more locations of a particular vendor within a geographical area. In some examples, reported incidents of fraud or potential fraud may also be shown on the vendor-based interactive mapping interface. Accordingly, a vendor may view the interface and quickly visualize where reported fraud is occurring near the vendor locations, whether one or more locations have more than average or expected reports of fraud, or the like.

At step 225, interactive mapping interface computing platform 110 may transmit or send the vendor-based interactive mapping interface to the external entity computing system 130. In some examples, transmitting or sending the vendor-based interactive mapping interface may cause the external entity computing system 130 to display the vendor-based interactive mapping interface on a display of the external entity computing system 130.

With reference to FIG. 2F, at step 226, external entity computing system 130 may receive and display the vendor-based interactive mapping interface. Similar to other interactive mapping interfaces described herein, the vendor-based interactive mapping interface may include one or more icons or interactive interface elements that may be selected to generate additional user interfaces providing additional information.

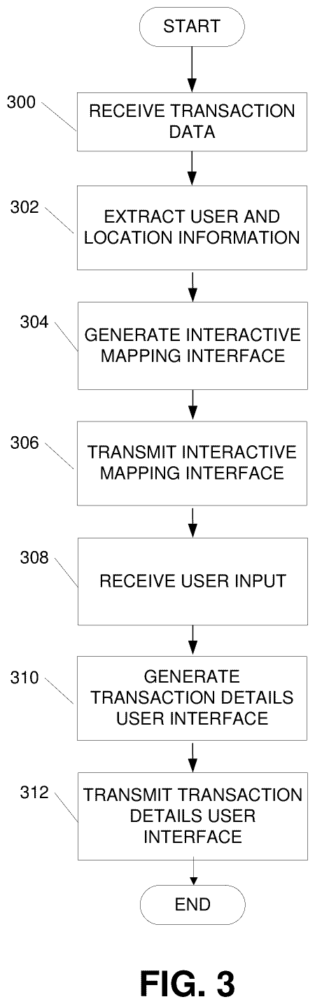

FIG. 3 is a flow chart illustrating one example method of generating interactive mapping interfaces in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a computing platform may receive transaction data. The transaction data may include data associated with a plurality of transactions executed by a plurality of users. In some examples, the users may be registered users associated with an enterprise organization associated with the computing platform. In some examples, the transaction data may be received in real-time or near real-time.

At step 302, the transaction data may be processed to extract user and location information associated with each transaction of the plurality of transactions. In some examples, machine learning may be used to process the transaction data, cluster data by user, extract location information, or the like.

At step 304, the computing platform may generate and interactive mapping interface. The interactive mapping interface may be generated based on the extracted user and location information. For instance, the interactive mapping interface may display a geographic area and may include interactive icons or selectable interface elements indicating a location of one or more transactions executed by the user within the geographic area.

In some examples, the interactive mapping interface may include a plurality of data layers that may be selected for display. For instance, a user may select to display different layers associated with display of data for one user, a plurality of users, by payment device, or the like. Accordingly, display of a data layer may be based on user selection of a respective data layer.

At step 306, the computing platform may transmit or send the interactive mapping interface to a user computing device associated with the user. In some examples, transmitting the interactive mapping interface to the user computing device may cause the user computing device to display the interactive mapping interface on a display of the user computing device.

At step 308, the computing platform may receive user input from the user computing device. In some examples, the user input may include input selecting or otherwise interacting with the interactive icon associated with a transaction.

At step 310, responsive to receiving the user input, the computing platform may generate an additional user interface, such as a transaction details interface. The transaction details interface may include additional details of the transaction associated with the icon selected via the user input. In some examples, the transaction details interface may further include a selectable option to report the transaction as fraudulent or potentially fraudulent.

At step 312, the computing platform may transmit or send the transaction details user interface to the user computing device. In some examples, transmitting or sending the transaction details user interface may cause the user computing device to display the transaction details interface on the display of the user computing device. In some examples, the transaction details interface may be displayed overlaying the interacting mapping interface.

As discussed, aspects described herein are directed to providing a dynamically generated visual indication of location information associated with processed transactions. This may enable users to quickly identify potentially fraudulent activity and take prompt action to mitigate risk to the user. While several aspects described herein are described in the context of transactions, aspects described may also be used to map login attempts associated with a user, user credentials, or the like. For instance, login attempts may be displayed via a dynamically generated interactive mapping interface to display a visual location of one or more login attempts. Accordingly, a user may quickly identify login attempts that may be made by unauthorized users.

As discussed, the transaction information may include information associated with a type of transaction, vendor, location and the like, as well as information related to how the transaction was conducted (e.g., mobile payment application, credit card, debit card, or the like), which card was used (e.g., last 4 digits of a credit or debit card may be shown), and the like. In some examples the icons displayed at a transaction location may be particular to the type of transaction or payment device. For instance, if a credit or debit card was used, the icon may be in a shape of a debit or credit card. If a mobile payment application was used, the icon may be in the shape of a mobile phone. Accordingly, selection of a transaction may quickly display transaction details that may be useful in identifying potential fraud.

Location information extracted from transaction data may be used to generate the interacting mapping interface. For instance, for in person transactions, a location of the user and vendor may be known and displayed on the interactive mapping interface. For online transactions, in some examples, a vendor location may be shown while a user location, if known, may also be shown. In some arrangements, a geographic region displayed via the interactive mapping interface may be expanded to accommodate locations of one or more online transactions (e.g., transactions performed with vendors outside of a region, country, or the like).

As discussed herein, data layers may be provided to enable users to customize a view and/or transactions or events shown in the interactive mapping interface. For instance, various data layers may be selected or deselected by a user to control display of data on the interactive mapping interface. In some examples, a user may select display of data layers associated with the user alone, the user with one or more additional household members, particular household members alone, credit card transactions, debit card transactions, transactions by particular card, mobile payment transactions, in person transactions, online transactions, login attempts, and the like.

In some examples, an interactive mapping interface may be generated for one or more vendors and may display transactions associated with a vendor within a geographical region. In some examples, transactions reported as fraud may be displayed on the interactive mapping interface to allow vendors to quickly identify retail locations that may be experiencing increased fraudulent activity.

In some examples, transactions or login attempt displayed via the interactive mapping interface may include an indication of one or more transactions or login attempts outside of an expected region, outside of expected behaviors, or the like. For instance, transactions or login attempts outside of expected transactions may be identified (e.g., based on machine learning analysis of a user's transaction history). In some examples, transactions or login attempts identified as unexpected may include a request for user input confirming validity of the transaction or login attempt. In some arrangements, icons having a different color may be used to identify transactions or login attempts outside of expected transactions or login attempts.

As discussed, one or more additional user interfaces may include a selectable option to report potential fraud for a transaction, report a login attempt that was not made by the user, or the like. This may cause the computing platform to initiate communication with one or more enterprise organization fraud reporting systems to enable the user to quickly report the issue. In some examples, transaction details associated with the transaction being reported may be transmitted from the computing platform to the one or more fraud reporting systems to pre-populate a fraud report associated with a transaction or login attempt. In some examples, communication with the fraud reporting system may be based on type of event. For instance, a transaction being reported as potential fraud may cause initiation of a communication session with a first fraud reporting system associated with transaction fraud, while an unauthorized login attempt may cause initiation of communication with a second, different fraud reporting system associated with unauthorized user access attempts. In some examples, the transaction or event details of the transaction or login attempt being reported may be used to identify which fraud reporting system should be connected for further reporting and analysis.

In some examples, user selection of an option to report a transaction or event as potentially unauthorized may also cause a notification of the report to be generated and transmitted to a relationship management team. In some examples, the notification may include transaction or event details that may be used by the relationship management team to contact the user, identify potential actions to mitigate risk, and the like.

In some examples, selection of the option to report an event as potentially unauthorized may cause display of another additional user interface including one or more selectable options associated with mitigating actions the user may select. For instance, the user interface may include an option to freeze or disable a payment card, an option to reset a password to avoid unauthorized login attempts, to establish alerts for different transaction amounts, transactions with certain vendors, or the like. In some examples, a request to connect with a fraud representative may be made from the interface. In some examples, selection of the request to connect with the fraud representative may cause generation and display of a unique one-time passcode that the user may provide to the fraud representative upon initiation of the communication session. In some examples, the one-time passcode may be sent to a pre-registered email address or phone number associated with the user, may be provided via a mobile application associated with the enterprise organization, or the like.

In some examples, a user may have an option to identify one or more transactions for further review. For instance, a user may right click on an icon associated with a transaction to flag it (e.g., modify an appearance of the icon, move the transaction to a queue for further review, or the like) for later review. Additionally or alternatively, a user may click and drag a transaction to a queue for further review. Accordingly, the user may confer with other household members to determine whether a suspicious transaction is actual fraud, for instance. In some examples, transactions flagged for further review may be forwarded by the user to another user in a household for review and confirmation of accuracy.

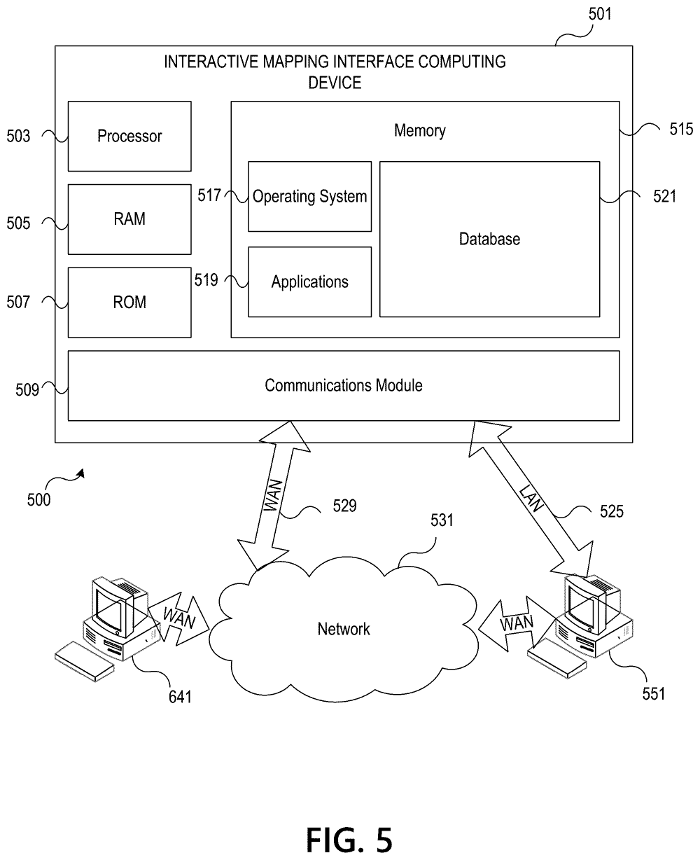

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include interactive mapping interface computing device 501 having processor 503 for controlling overall operation of interactive mapping interface computing device 501 and its associated components, including Random Access Memory (RAM) 505, Read-Only Memory (ROM) 507, communications module 509, and memory 515. Interactive mapping interface computing device 501 may include a variety of computer readable media. Computer readable media may be any available media that may be accessed by interactive mapping interface computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by interactive mapping interface computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on interactive mapping interface computing device 501. Such a processor may execute computer-executable instructions stored on a computer-readable medium.

Software may be stored within memory 515 and/or storage to provide instructions to processor 503 for enabling interactive mapping interface computing device 501 to perform various functions as discussed herein. For example, memory 515 may store software used by interactive mapping interface computing device 501, such as operating system 517, application programs 519, and associated database 521. Also, some or all of the computer executable instructions for interactive mapping interface computing device 501 may be embodied in hardware or firmware. Although not shown, RAM 505 may include one or more applications representing the application data stored in RAM 505 while interactive mapping interface computing device 501 is on and corresponding software applications (e.g., software tasks) are running on interactive mapping interface computing device 501.

Communications module 509 may include a microphone, keypad, touch screen, and/or stylus through which a user of interactive mapping interface computing device 501 may provide input, and may also include one or more of a speaker for providing audio output and a video display device for providing textual, audiovisual and/or graphical output. Computing system environment 500 may also include optical scanners (not shown).

Interactive mapping interface computing device 501 may operate in a networked environment supporting connections to one or more other computing devices, such as computing device 541 and 551. Computing devices 541 and 551 may be personal computing devices or servers that include any or all of the elements described above relative to interactive mapping interface computing device 501.

The network connections depicted in FIG. 5 may include Local Area Network (LAN) 525 and Wide Area Network (WAN) 529, as well as other networks. When used in a LAN networking environment, interactive mapping interface computing device 501 may be connected to LAN 525 through a network interface or adapter in communications module 509. When used in a WAN networking environment, interactive mapping interface computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive transaction data including a plurality of transactions executed by a plurality of users;
extract, from the transaction data, user information and location information for each transaction of the plurality of transactions;
generate, based on the user information and the location information, an interactive mapping interface, wherein the interactive mapping interface includes an interactive icon identifying at least one transaction of the plurality of transactions executed by a user and a location of the transaction;
transmit the interactive mapping interface to a user computing device, wherein transmitting the interactive mapping interface to the user computing device causes the user computing device to display the interactive mapping interface on a display of the user computing device;
receive, from the user computing device and via the interactive mapping interface, user input selecting the interactive icon identifying the at least one transaction;
responsive to receiving the user input, generate a transaction details user interface including additional details of the at least one transaction; and
transmit the transaction details user interface to the user computing device, wherein transmitting the transaction details user interface to the user computing device causes the user computing device to display the transaction details user interface on the display of the user computing device and overlaying the interactive mapping interface.

2. The computing platform of claim 1, wherein the interactive mapping interface includes a plurality of data layers.

3. The computing platform of claim 2, wherein each data layer of the plurality of data layers is displayed based on user selection of a respective data layer.

4. The computing platform of claim 1, wherein the transaction details user interface includes a selectable option to report the at least one transaction as potentially fraudulent.

5. The computing platform of claim 4, further including instructions that, when executed, cause the computing platform to:
receive additional user input selecting the selectable option to report the at least one transaction as potentially fraudulent;
generate an instruction to initiate a communication session between a fraud reporting system and the user computing device; and
transmit the generated instruction to the fraud reporting system, wherein transmitting the instruction causes the fraud reporting system to initiate the communication session with the user computing device.

6. The computing platform of claim 1, wherein the transaction data is received in real-time.

7. The computing platform of claim 1, wherein extracting, from the transaction data, user information and location information for each transaction of the plurality of transactions includes processing the transaction data using a machine learning model.

8. A method, comprising:
receiving, by a computing platform, the computing platform having at least one processor and memory, transaction data including a plurality of transactions executed by a plurality of users;
extracting, by the at least one processor and from the transaction data, user information and location information for each transaction of the plurality of transactions;
generating, by the at least one processor and based on the user information and the location information, an interactive mapping interface, wherein the interactive mapping interface includes an interactive icon identifying at least one transaction of the plurality of transactions executed by a user and a location of the transaction;
transmitting, by the at least one processor, the interactive mapping interface to a user computing device, wherein transmitting the interactive mapping interface to the user computing device causes the user computing device to display the interactive mapping interface on a display of the user computing device;
receiving, by the at least one processor and from the user computing device and via the interactive mapping interface, user input selecting the interactive icon identifying the at least one transaction;
responsive to receiving the user input, generating, by the at least one processor, a transaction details user interface including additional details of the at least one transaction; and
transmitting, by the at least one processor, the transaction details user interface to the user computing device, wherein transmitting the transaction details user interface to the user computing device causes the user computing device to display the transaction details user interface on the display of the user computing device and overlaying the interactive mapping interface.

9. The method of claim 8, wherein the interactive mapping interface includes a plurality of data layers.

10. The method of claim 9, wherein each data layer of the plurality of data layers is displayed based on user selection of a respective data layer.

11. The method of claim 8, wherein the transaction details user interface includes a selectable option to report the at least one transaction as potentially fraudulent.

12. The method of claim 11, further including:
receiving, by the at least one processor, additional user input selecting the selectable option to report the at least one transaction as potentially fraudulent;
generating, by the at least one processor, an instruction to initiate a communication session between a fraud reporting system and the user computing device; and
transmitting, by the at least one processor, the generated instruction to the fraud reporting system, wherein transmitting the instruction causes the fraud reporting system to initiate the communication session with the user computing device.

13. The method of claim 8, wherein the transaction data is received in real-time.

14. The method of claim 8, wherein extracting, from the transaction data, user information and location information for each transaction of the plurality of transactions includes processing the transaction data using a machine learning model.

15. One or more non-transitory computer-readable media storing instructions that, when executed by a computing platform comprising at least one processor, memory, and a communication interface, cause the computing platform to:
receive transaction data including a plurality of transactions executed by a plurality of users;
extract, from the transaction data, user information and location information for each transaction of the plurality of transactions;
generate, based on the user information and the location information, an interactive mapping interface, wherein the interactive mapping interface includes an interactive icon identifying at least one transaction of the plurality of transactions executed by a user and a location of the transaction;
transmit the interactive mapping interface to a user computing device, wherein transmitting the interactive mapping interface to the user computing device causes the user computing device to display the interactive mapping interface on a display of the user computing device;
receive, from the user computing device and via the interactive mapping interface, user input selecting the interactive icon identifying the at least one transaction;
responsive to receiving the user input, generate a transaction details user interface including additional details of the at least one transaction; and
transmit the transaction details user interface to the user computing device, wherein transmitting the transaction details user interface to the user computing device causes the user computing device to display the transaction details user interface on the display of the user computing device and overlaying the interactive mapping interface.

16. The one or more non-transitory computer-readable media of claim 15, wherein the interactive mapping interface includes a plurality of data layers.

17. The one or more non-transitory computer-readable media of claim 16, wherein each data layer of the plurality of data layers is displayed based on user selection of a respective data layer.

18. The one or more non-transitory computer-readable media of claim 15, wherein the transaction details user interface includes a selectable option to report the at least one transaction as potentially fraudulent.

19. The one or more non-transitory computer-readable media of claim 18, further including instructions that, when executed, cause the computing platform to:
receive additional user input selecting the selectable option to report the at least one transaction as potentially fraudulent;
generate an instruction to initiate a communication session between a fraud reporting system and the user computing device; and
transmit the generated instruction to the fraud reporting system, wherein transmitting the instruction causes the fraud reporting system to initiate the communication session with the user computing device.

20. The one or more non-transitory computer-readable media of claim 15, wherein extracting, from the transaction data, user information and location information for each transaction of the plurality of transactions includes processing the transaction data using a machine learning model.
